(19) United States
(12) Patent Application Publication
(10) Pub. No.: US 2002/0170933 A1
(43) Pub. Date: Nov. 21, 2002

(54) Tool pouch with swiveling removable belt attachment

(76) Inventor: John H. Martin, Woodland Hills, CA (US)

Correspondence Address: Brian M. Berliner, O'MELVENY & MYERS LLP, 400 South Hope Street, Los Angeles, CA, 90071-2899, US

(21) Appl. No.: 10/154,182

(22) Filed: May 21, 2002

Related U.S. Application Data
(60) Provisional application No. 60/292,475, filed on May 21, 2001.

(51) Int. Cl. B65D 25/52; A01K 97/06; A45F 5/00; A45C 1/04; F41C 33/02; F42B 39/02

(52) U.S. Cl. 224/197; 224/666; 224/271; 224/904

(57) ABSTRACT

A tool pouch comprises a back layer of durable sheet material, and an outer layer of compliant material and a stud plate attached to opposite sides of the back layer. The back layer has a front side, a back side, a top edge, and a lower perimeter extending from a first end of the top edge to a second end of the top edge between the front side and the back side. The outer layer of compliant material is attached to front side of the back layer around a majority of the lower perimeter of the back layer, and attached to the back layer between edges of the lower perimeter to form a plurality of pockets. Each of the plurality of pockets has an opening oriented towards the top edge of the back layer. The stud plate is attached to the back side of the back layer, the stud plate comprising a base plate and a stud fixed to the base plate, for providing a freely swiveling, removable attachment to a retainer that may be worn on a user's waistband. The stud protrudes from the back side of the back layer, and comprises a post attached to the stud plate and a cap covering an end of the post distal from the stud plate. The post is oblong in cross-section for providing a locking feature.

### CROSS-REFERENCE TO RELATED APPLICATION

This application claims priority pursuant to 35 U.S.C. §119(e) to U.S. Provisional Application No. 60/292,475, filed May 21, 2002, which application is specifically incorporated herein, in its entirety, by reference.

### BACKGROUND OF THE INVENTION

1. Field of the Invention

The present invention relates to holsters and pouches for hand tools, and in particular, to tool pouches and holsters for hand-held tools such as are worn in the construction trades.

2. Description of Related Art

Rugged pouches for carrying hand held tools have long been worn by members of the construction trades, such as carpenters and the like. In certain specialized trades, for example, the floor covering installation trades, various specialized pouches are available that are designed to hold specific tools commonly used in the trade. During a typical workday, a craftsperson frequently and repetitiously removes and replaces every tool in her tool pouch dozens, and perhaps even hundreds, of times. In many trades, tool pouches are thus often designed be worn on or near the waist belt, and to hold hand tools in a position to facilitate rapid grasping, removal, and replacement by the craftsperson. Such pouches are frequently designed to loosely hold each tool in a vertically oriented open pocket. The tools are preferably not secured to the pouch to improve the ease with which they may be removed and replaced. Such pouches have proven to be very rugged and useful in operation.

However, a disadvantage of waistband-mounted pouches is that tools can inadvertently drop out rather more easily than is desired when the craftsperson shifts positions during work, and the tool pouch may interfere with some movements, such as squatting, commonly performed during the course of work. Also, traditional tool pouches are not easily removed and set aside from the craftsperson's belt. It is desired, therefore, to provide an improved tool pouch that retains the advantages of traditional waistband-mounted pouches, while being more easily removed and replaced on the user's belt, less likely to drop its tools as the wearer of the pouch moves about and changes position, and less likely to interfere with the wearer's movement.

### SUMMARY OF THE INVENTION

The present invention solves the tool-dropping problem associated with prior-art pouches by attaching the pouch to the user using a freely swiveling fastener. The freely swiveling fastener permits the tool pouch to retain its vertical orientation as the wearer moves about and shifts position. The tools are thus better retained in their respective pouches, and less likely to drop out. The freely swiveling fastener is preferably removably attached to the wearer's belt with a stud-and-groove type fastener. The swiveling operation of pouches according to the present invention can also increase comfort of the wearer by pivoting to accommodate changes in body position.

Various stud-and-groove type fastening devices have long been available for removably fastening two objects together in freely swiveling relation. Despite the long availability of such fastening devices, they have not heretofore been applied for use with waistband-mounted tool pouches. The present invention provides overcomes the limitations of prior-art, waistband-mounted tool pouches by attaching a stud plate of a suitable stud-and-groove fastening device to the back of a waistband-mounted pouch. The stud plate may be adapted from one of the various stud-and-groove type fasteners known in the art, or may be of a new design. In either case, the stud plate is designed to mate with a retainer so as to permit the tool pouch to be readily attached and detached, and to swivel freely while being locked to the retainer. The retainer may be attached to a suitable spring clip for clipping to the waistband of a user.

A more complete understanding of the tool pouch with swiveling removable belt attachment will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a exploded assembly drawing showing a tool pouch assembly according to the present invention.

FIG. 2 is a back view of a tool pouch with attached stud plate.

FIG. 3 is a side view of an exemplary tool pouch and swiveling attachment.

FIG. 4 is a plan view of an exemplary retainer and belt clip for a swiveling attachment.

FIG. 5 is a cross-sectional view of the retainer and belt clip shown in FIG. 5.

FIG. 6 is a plan view of an exemplary stud plate for use with the retainer shown in FIGS. 4-5.

FIG. 7 is a cross-sectional view of the stud plate shown in FIG. 6.

### DETAILED DESCRIPTION OF THE PREFERRED EMBODIMENT

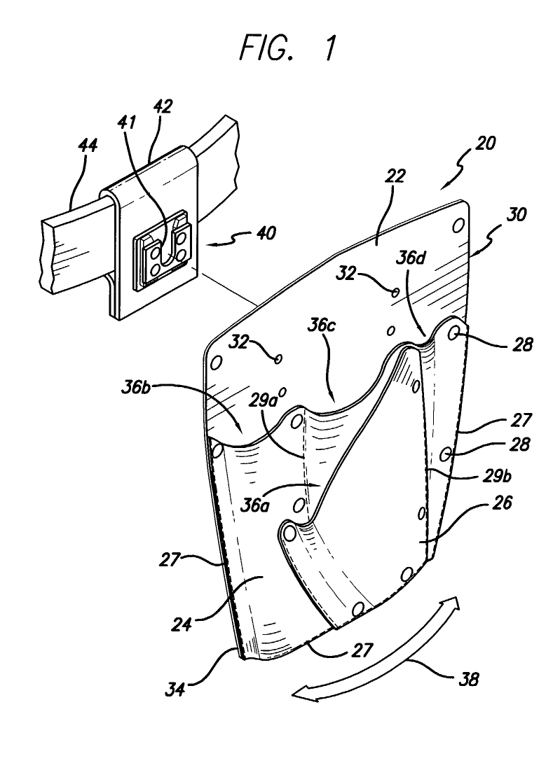

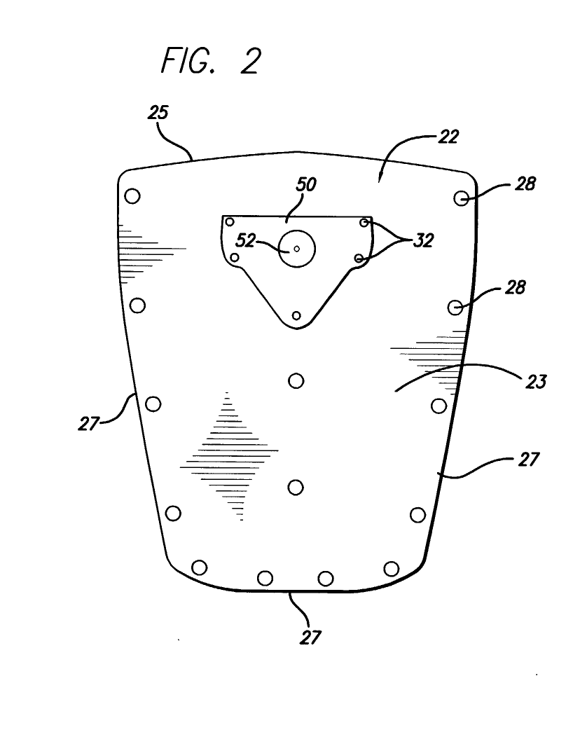

FIGS. 1-3 show different views of an exemplary tool pouch assembly 20. The assembly comprises a tool pouch 30, grooved retainer 40, and belt clip 42. Tool pouch 30 is generally quadrangular in outline, and comprises three primary layers: back 22, middle layer 24, and outer layer 26. Layers 22, 24, 26 comprise a durable sheet material, preferably leather, and are fastened together in stacked relation using stitching 34 and metal rivets 28. Various separate pockets 36a-d are formed between the layers, as shown. Back 22 is attached to a stud plate 50 (shown in FIG. 2) by rivets 32. Stud plate 50 mates with retainer 40 on belt clip 42, which may be clipped to any suitable waist band or belt 44 worn by a user. Stud 52, which is rigidly attached to stud plate 50, may be inserted into the groove 41 of the retainer 30 by turning the pouch to an appropriate angle relative to groove 41, so that the distal end of stud 52 fits into the groove 41. After stud 52 is inserted into the retainer 40, pouch 30 may swivel relative to its resting, vertical position by at least about 90° each way while remaining locked to retainer. Removal of the stud is accomplished by turning the pouch past its locking point (for example, past 90°) while sliding stud 52 out of groove 41.

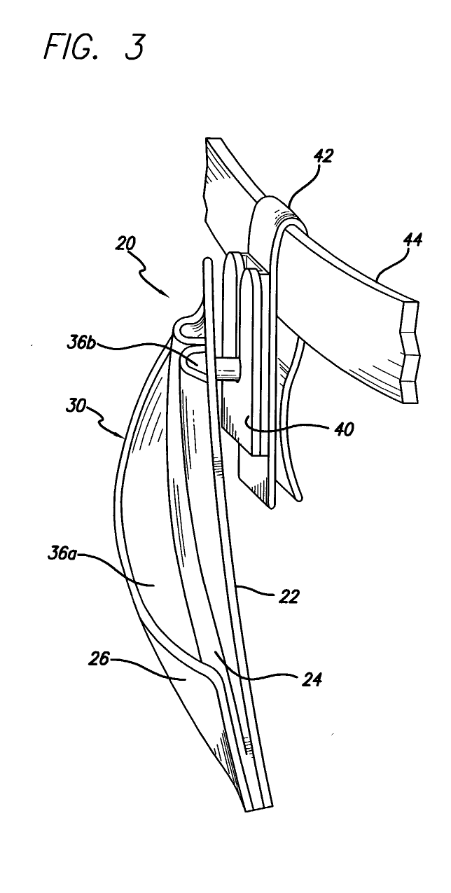

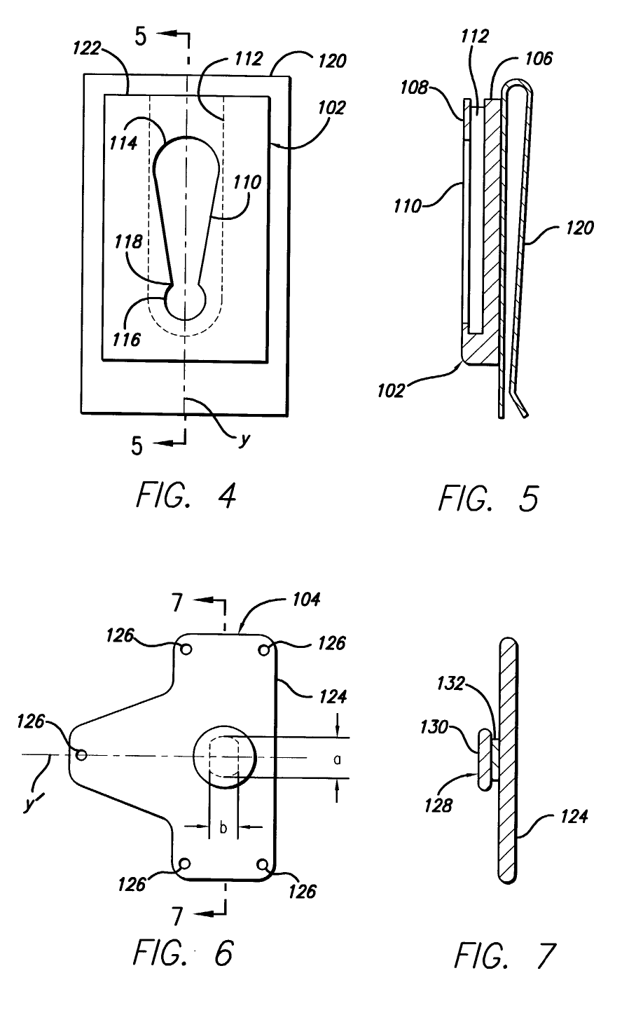

Retainer 40 and stud plate 50 generally comprise a two-part device for removably attaching the tool pouch 30 to a waist band of a user, and for holding the tool pouch in freely swiveling relation to the waistband. Any suitable swiveling fastener may be used. An exemplary swiveling fastener is described below in connection with FIGS. 4-7. When attached to belt 44 by a suitable swiveling fastener, pouch 30 is free to swivel in the direction indicated by arrow 38 while remaining locked to the retainer through a predetermined angle of rotation, such as about 180 degrees.

Tool pouch 30 is preferably constructed from stacked layers of a tough, pliable material, such as leather. Back 22 may be a relatively stiff piece of material, and layers 24, 26 may be somewhat more compliant or pliable. Back 22 has a front side 21, a back side 23, a top edge 25, and a lower perimeter 27 extending from a first end of the top edge 25 to a second end of the top edge. Middle layer 24 is attached to the front side 21 around a substantial portion of the lower perimeter 27, and also at positions between the edges of the lower perimeter, e.g., along rivet line 29a and stitch/rivet line 29b, thereby forming pockets 36b-d. Pockets 36b-d each have an opening oriented towards top edge 25. Outer layer 26 is attached to the back layer 22 over pockets 36b-d, to form an outer pocket 36a. In an alternative embodiment (not shown), outer layer 26 and outer pocket 36a are omitted.

The layers 22, 24, 26 are preferably fastened together by stitching with a durable thread. The stitching is preferably reinforced at stress points, such as at the pocket corners or openings, using metallic rivets. The rivets prevent pouch 30 from delaminating in the event that the stitching is cut or worn through.

For use by installers of floor coverings, it is particularly preferable to configure pockets 36a-36d as shown. Outer pocket 36a is preferably relatively shallow but wide, and has a large, easily accessed opening for holding a relatively thick, short article such as a tape measure. Pockets 36b, 36c are intermediate in size and aspect ratio, for holding hand held tools such as razor knives. Another pocket 36d is relatively long and narrow with a small opening, for holding objects such as screwdrivers by their elongated shafts. The entire pouch 30 is preferably not much larger than a man's hand, e.g., roughly 6 inches by 6 inches. For greater ergonomic performance, pouch 30 is preferably designed to hold a few selected, frequently-used tools for the worker. The easily removable, freely swiveling fastener further enhances comfort and convenience for the user, by allowing the tool pouch to swing out of the user's way, and providing for convenient detachment and reattachment as desired.

A suitable swiveling fastener may be comprised of a retainer 102 and a matching stud plate 104, shown in FIGS. 4-5 and FIGS. 6-7, respectively. Retainer 102 comprises a base 106, and a face plate 108 covering a groove or recess 112 that extends through the base. Groove 112 is partially revealed by an opening 110 in the face plate, for insertion of a stud of the stud plate 102. Opening 112 has a stud entrance aperture 114 connected along an operative axis “y” to a swivel seat aperture 116. The stud entrance aperture 114 is separated from the swivel seat aperture 116 by a narrowing of opening 110 forming a neck 118. In an alternative embodiment (not shown), the opening 110 may extend through edge 122 of the face plate 108, with its entrance aperture located at the edge 122.

A suitable belt clip 120 may be attached to base 106 opposite to face plate 108. Belt clip 120 and retainer 102 may be made of any durable material, for example, steel or stainless steel. A U-shaped spring clip may be used for belt clip 120, or any other suitable device for clipping to a belt or waist band.

Stud plate 104 comprises a base 124 having a plurality of spaced-apart attachment features, for example, through holes 126, for attaching to the back of a tool pouch (e.g., back 22 of tool pouch 30). A stud 128 projects from a face of base 124. Stud 128 comprises a distal cap 130 supported by a post 132. Distal cap 130 is sized to fit into entrance aperture 114 of the retainer 102, while being too large to pass through the swivel seat aperture 116. Cap 130 preferably covers the top of post 132 around its perimeter, as can be seen in FIG. 6. Post 132 is oblong in cross-section, i.e., is sized in a first dimension “a” to be too large to pass through neck 118 of opening 110, while being sufficiently small in a second dimension “b,” orthogonal to dimension “a,” to pass through neck 118. The stud plate 104 may comprise any suitable durable material, for example, steel or stainless steel.

Thus, once post 132 is seated in the swivel seat aperture 116, it may be removed by twisting the stud plate 104 (and its attached tool pouch) by 90° in either direction relative to its resting position, slipping the post 132 through neck 118, and pulling stud 128 out through the entrance aperture 116. In its resting position, axis “y′” of the stud plate is generally vertical and aligned with the operative axis “y” of opening 110, and stud 128 is effectively locked to retainer 30 while still allowing the stud plate and its attached tool pouch to freely swivel around axis “y′”. In an alternative embodiment, having an opening extending to the edge 122 of the retainer face plate, the stud may be removed by lifting it past edge 122 out of the opening.

Having thus described a preferred embodiment of a tool pouch with swiveling removable belt attachment, it should be apparent to those skilled in the art that certain advantages of the within system have been achieved. It should also be appreciated that various modifications, adaptations, and alternative embodiments thereof may be made within the scope and spirit of the present invention. For example, a specific configuration of tool pouch has been illustrated, but it should be apparent that the inventive concepts described above would be equally applicable to other similar types of tool pouches. For further example, a specific swiveling fastener for removably attaching the tool pouch to a waistband has been illustrated, but any suitable two-part swiveling fastener, of which examples may be found in the prior art or which may be developed, may be substituted to the fastener described herein. The invention is further defined by the following claims.

What is claimed is:

1. A tool pouch, comprising:
a back layer of durable sheet material, the back layer having a front side, a back side, a top edge, and a lower perimeter extending from a first end of the top edge to a second end of the top edge between the front side and the back side;
an outer layer of compliant material attached to front side of the back layer around a majority of the lower perimeter of the back layer, and attached to the back layer between edges of the lower perimeter to form a plurality of pockets, each of the plurality of pockets having an opening oriented towards the top edge of the back layer; and
a stud plate attached to the back layer, the stud plate comprising a base plate and a stud fixed to the base plate and protruding from the back side of the back layer, the stud comprising a post attached to the stud plate and a cap covering an end of the post distal from the stud plate, the post being oblong in cross-section.

2. The tool pouch of claim 1, further comprising a second outer layer of compliant material over the plurality of pockets and attached to the back layer to form an outer pocket.

3. The tool pouch of claim 2, wherein the outer pocket has an opening oriented towards the top edge of the back layer.

4. The tool pouch of claim 1, wherein the compliant material is leather.

5. The tool pouch of claim 1, wherein the outer layer and the back layer are stitched and riveted together.

6. The tool pouch of claim 1, wherein the stud plate comprises a material selected from steel or stainless steel.

7. The tool pouch of claim 1, wherein the stud plate is riveted to the back layer.

8. The tool pouch of claim 1, wherein the stud plate lacks any moving part.

9. The tool pouch of claim 7, wherein the cap has a circular disc shape.

10. A tool pouch assembly for clipping to a waistband, the assembly comprising:
a tool pouch having a plurality of pockets attached to a back layer, each of the plurality of pockets made of a compliant material and having an opening oriented towards a top edge of the back layer;
attachment means for removably attaching the tool pouch and for holding the tool pouch in freely swiveling relation to a waistband of a user, the attachment means attached to a side of the back layer opposite to the plurality of pockets and configured to permit detaching the tool pouch from the waistband by rotating the tool pouch relative to the waistband from a rest position to a removal position; and
clipping means for removably clipping the tool pouch assembly to the waistband, the clipping means separate from and attached to the attachment means.

11. The tool pouch assembly of claim 10, wherein the compliant material is leather.

12. The tool pouch assembly of claim 10, wherein the attachment means comprises a stud plate in combination with a retainer, the stud plate having a stud protruding from a base plate, the stud having a post covered by a cap, the post being oblong in cross-section and shaped to fit through an opening of the retainer.

13. The tool pouch assembly of claim 12, wherein the retainer comprises a base having a recess covered by a face plate, the opening being in the faceplate and exposing a portion of the recess.

14. The tool pouch assembly of claim 12, wherein the stud plate and the retainer comprise a material selected from steel or stainless steel.

15. The tool pouch assembly of claim 12, wherein the stud plate lacks any moving part.

16. The tool pouch assembly of claim 12, wherein the stud plate is attached to the back layer of the tool pouch.

17. The tool pouch assembly of claim 12, wherein the retainer is attached to the back layer of the tool pouch.

18. The tool pouch assembly of claim 12, wherein the clipping means comprises a U-shaped spring clip.

19. The tool pouch assembly of claim 12, wherein the clipping means is permanently attached to the retainer.
